(19) United States
(12) Patent Application Publication
(10) Pub. No.: US 2017/0171321 A1
(43) Pub. Date: Jun. 15, 2017

(54) METHODS AND DEVICES FOR MANAGING ACCOUNTS

(71) Applicant: Xiaomi Inc., Beijing (CN)

(72) Inventors: Yi GAO, Beijing (CN); Hongqiang WANG, Beijing (CN); Yunyuan GE, Beijing (CN)

(73) Assignee: Xiaomi Inc., Beijing (CN)

(21) Appl. No.: 15/370,462

(22) Filed: Dec. 6, 2016

(30) Foreign Application Priority Data
Dec. 10, 2015 (CN) 201510920254.X

(51) Int. Cl. H04L 29/08

(52) U.S. Cl. CPC H04L 67/143; H04L 67/42

(57) ABSTRACT

The present disclosure relates to methods and devices for managing accounts. A method may include receiving, by a processor, a first log-out request for logging out a plurality of target accounts corresponding to at least one target application. A method may further include for each target application of the at least one target application, sending, from the processor to a target application server corresponding to the target application, a second log-out request that carries information of the plurality of target accounts, for the target application server to log out the plurality of target accounts according to the information of the plurality of target accounts. Aspects of the present disclosure can allow for quickly logging out a plurality of target accounts, which may save time for users and improve user experience.

### CROSS-REFERENCE TO RELATED APPLICATIONS

The present application is based upon and claims priority to Chinese Patent Application No. CN201510920254.X, filed Dec. 10, 2015, the entire contents of which is incorporated herein by reference.

### TECHNICAL FIELD

The present disclosure generally relates to the field of communication technology, and more particularly, to methods and devices for managing accounts.

### BACKGROUND

Currently, users log into their accounts for an application through smart devices such as mobile phones, and information of these accounts is stored in the corresponding application. When a user needs to lend his mobile phone to others, since the user generally does not want others to log in the user's own account for an application or check stored information of the user's account, the user needs to log out his account which is currently logged in. If the user currently has more than one account logged in, which can correspond to one or more applications, the user needs to log out his accounts one by one, and delete stored information of his accounts piece by piece. This can be very time consuming and thus can provide poor user experience.

### SUMMARY

According to a first aspect of embodiments of the present disclosure, there is provided a method for managing accounts. The method may include receiving, by a processor, a first log-out request for logging out a plurality of target accounts corresponding to at least one target application. The method may further include, for each target application of the at least one target application, sending, from the processor to a target application server corresponding to the target application, a second log-out request that carries information of the plurality of target accounts, for the target application server to log out the plurality of target accounts according to the information of the plurality of target accounts.

According to a second aspect of embodiments of the present disclosure, there is provided a method for managing accounts. The method may include receiving, by a processor, a log-in request for logging a target account into a target application. The method may further include sending the log-in request from the processor to a target application server corresponding to the target application, for the target application server to verify and log the target account into the target application according to the log-in request. The receiving of a log-in request for logging a target account into a target application may include detecting that a log-in request for logging into a target application is input in a log-in interface of the target application. The receiving of a log-in request for logging a target account into a target application may further include identifying, to an account-managing module, the target account of the log-in request, the account-managing module configured to manage log-in states and log-out states of accounts for the target application.

According to a third aspect of embodiments of the present disclosure, there is provided a method for managing accounts. The method may include receiving, by a processor, a third log-out request for logging a target account out of a target application. The method may further include sending, from the processor to a target application server corresponding to the target application, a fourth log-out request that carries information of the target account, for the target application server to log out the target account according to the information of the target account. The receiving of a third log-out request for logging a target account out of a target application may include detecting that a third log-out request for logging out the target application is input in a log-out interface of the target application. The receiving of a third log-out request for logging a target account out of a target application may further include identifying, to an account-managing module, the target account of the third log-out request, the account-managing module configured to manage log-in states and log-out states of accounts for the target application.

According to a fourth aspect of embodiments of the present disclosure, there is provided a device for managing accounts. The device may include a processor and a memory for storing instructions executable by the processor. The processor may be configured to perform an operation of receiving a first log-out request for logging out a plurality of target accounts corresponding to at least one target application. The processor may be further configured to perform an operation of, for each target application of the at least one target application, sending a second log-out request that carries information of the plurality of target accounts to a target application server corresponding to the target application, for the target application server to log out the plurality of target accounts according to the information of the plurality of target accounts.

According to a fifth aspect of embodiments of the present disclosure, there is provided a device for managing accounts. The device may include a processor and a memory for storing instructions executable by the processor. The processor may be configured to perform an operation of receiving a log-in request for logging a target account into a target application. The processor may be further configured to perform an operation of sending the log-in request to a target application server corresponding to the target application, for the target application server to verify and log the target account into the target application according to the log-in request. The receiving of a log-out request for logging a target account out of a target application may include detecting that a log-in request for logging into a target application is input in a log-in interface of the target application. The receiving of a log-out request for logging a target account out of a target application may further include identifying, to an account-managing module, the target account of the log-in request, the account-managing module configured to manage log-in states and log-out states of accounts for the target application.

According to a sixth aspect of embodiments of the present disclosure, there is provided a device for managing accounts. The device may include a processor and a memory for storing instructions executable by the processor. The processor may be configured to perform an operation of receiving a third log-out request for logging a target account out of a target application. The processor may be further configured to perform an operation of sending, to a target application server corresponding to the target application, a fourth log-out request that carries information of the target account, for the target application server to log out the target account according to the information of the target account. The receiving of a third log-out request for logging a target account out of a target application may include detecting that a third log-out request for logging out the target application is input in a log-out interface of the target application. The receiving of a third log-out request for logging a target account out of a target application may further include identifying, to an account-managing module, the target account of the third log-out request, the account-managing module configured to manage log-in states and log-out states of accounts for the target application.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart illustrating a method for managing accounts according to an exemplary embodiment of the present disclosure;

FIG. 2 is a flow chart illustrating aspects of a method for managing accounts according to an exemplary embodiment of the present disclosure;

FIG. 3 is a flow chart illustrating aspects of a method for managing accounts according to an exemplary embodiment of the present disclosure;

FIG. 4 is a flow chart illustrating a method for managing accounts according to an exemplary embodiment of the present disclosure;

FIG. 5 is a flow chart illustrating a method for managing accounts according to an exemplary embodiment of the present disclosure;

FIG. 6 is a flow chart illustrating a method for managing accounts according to an exemplary embodiment of the present disclosure;

FIG. 7 is a flow chart illustrating a method for managing accounts according to an exemplary embodiment of the present disclosure;

FIG. 8 is a schematic diagram illustrating a scenario for managing accounts according to an exemplary embodiment of the present disclosure;

FIG. 9 is a flow chart illustrating a method for managing accounts according to an exemplary embodiment of the present disclosure;

FIGS. 10A and 10B are schematic diagrams illustrating scenarios of managing accounts according to an exemplary embodiment of the present disclosure;

FIG. 11 is a flow chart illustrating a method for managing accounts according to an exemplary embodiment of the present disclosure;

FIG. 12 is a flow chart illustrating aspects of a method for managing accounts according to an exemplary embodiment of the present disclosure;

FIG. 13 is a flow chart illustrating aspects of a method for managing accounts according to an exemplary embodiment of the present disclosure;

FIG. 14 is a flow chart illustrating a method for managing accounts according to an exemplary embodiment of the present disclosure;

FIG. 15 is a flow chart illustrating a method for managing accounts according to an exemplary embodiment of the present disclosure; (00261 FIG. 16 is a flow chart illustrating a method for managing accounts according to an exemplary embodiment of the present disclosure;

FIG. 17 is a flow chart illustrating a method for managing accounts according to an exemplary embodiment of the present disclosure;

FIG. 18 is a flow chart illustrating a method for managing accounts according to an exemplary embodiment of the present disclosure;

FIG. 19 is a flow chart illustrating aspects of a method for managing accounts according to an exemplary embodiment of the present disclosure;

FIG. 20 is a flow chart illustrating aspects of a method for managing accounts according to an exemplary embodiment of the present disclosure;

FIG. 21 is a flow chart illustrating a method for managing accounts according to an exemplary embodiment of the present disclosure;

FIG. 22 is a flow chart illustrating a method for managing accounts according to an exemplary embodiment of the present disclosure;

FIG. 23 is a flow chart illustrating a method for managing accounts according to an exemplary embodiment of the present disclosure;

FIG. 24 is a block diagram illustrating a device for managing accounts according to an exemplary embodiment of the present disclosure;

FIG. 25 is a block diagram illustrating aspects of a device for managing accounts according to an exemplary embodiment of the present disclosure;

FIG. 26 is a block diagram illustrating aspects of a device for managing accounts according to an exemplary embodiment of the present disclosure;

FIG. 27 is a block diagram illustrating aspects of a device for managing accounts according to an exemplary embodiment of the present disclosure;

FIG. 28 is a block diagram illustrating aspects of a device for managing accounts according to an exemplary embodiment of the present disclosure;

FIG. 29 is a block diagram illustrating aspects of a device for managing accounts according to an exemplary embodiment of the present disclosure;

FIG. 30 is a block diagram illustrating a device for managing accounts according to an exemplary embodiment of the present disclosure;

FIG. 31 is a block diagram illustrating a device for managing accounts according to an exemplary embodiment of the present disclosure;

FIG. 32 is a block diagram illustrating a device for managing accounts according to an exemplary embodiment of the present disclosure;

FIG. 33 is a block diagram illustrating a device for managing accounts according to an exemplary embodiment of the present disclosure;

FIG. 34 is a block diagram illustrating a device for managing accounts according to an exemplary embodiment of the present disclosure;

FIG. 35 is a block diagram illustrating aspects of a device for managing accounts according to an exemplary embodiment of the present disclosure;

FIG. 36 is a block diagram illustrating aspects of a device for managing accounts according to an exemplary embodiment of the present disclosure;

FIG. 37 is a block diagram illustrating a device for managing accounts according to an exemplary embodiment of the present disclosure;

FIG. 38 is a block diagram illustrating a device for managing accounts according to an exemplary embodiment of the present disclosure;

FIG. 39 is a block diagram illustrating a device for managing accounts according to an exemplary embodiment of the present disclosure;

FIG. 40 is a block diagram illustrating a device for managing accounts according to an exemplary embodiment of the present disclosure;

FIG. 41 is a block diagram illustrating aspects of a device for managing accounts according to an exemplary embodiment of the present disclosure;

FIG. 42 is a block diagram illustrating aspects of a device for managing accounts according to an exemplary embodiment of the present disclosure;

FIG. 43 is a block diagram illustrating a device for managing accounts according to an exemplary embodiment of the present disclosure;

FIG. 44 is a block diagram illustrating a device for managing accounts according to an exemplary embodiment of the present disclosure; and

FIG. 45 is a block diagram illustrating a device for managing accounts according to an exemplary embodiment of the present disclosure.

### DETAILED DESCRIPTION

Reference will now be made in detail to exemplary embodiments, examples of which are illustrated in the accompanying drawings. The following description refers to the accompanying drawings, in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the present disclosure as recited in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The terms used herein are merely for describing particular embodiments, rather than limiting the present disclosure. As used in the present disclosure and the appended claims, terms in singular forms such as “a”, “said” and “the” are intended to also include plural forms, unless explicitly dictated otherwise. It should also be understood that the term “and/or” used herein means any one or any possible combination of one or more associated listed items. Also, as used in the description herein and throughout the claims that follow, the meaning of “in” includes “in” and “on” unless the context clearly dictates otherwise. It will be further understood that the terms “may include,” “including,” “comprises.” and/or “comprising,” when used in this specification, specify the presence of stated features, operations, elements, and/or components, but do not preclude the presence or addition of one or more other features, operations, elements, components, and/or groups thereof.

It should be understood that, although the disclosure may describe an element with a term first, second, or third, etc., the element is not limited by these terms. These terms are merely for distinguishing among elements of the same kind. For example, without departing from the scope of the present disclosure, a first element can also be referred to as a second element. Similarly, a second element can also be referred to as a first element. Depending on the context, a term “if” as used herein can be interpreted as “when”, “where” or “in response to”.

FIG. 1 is a flow chart illustrating a method for managing accounts according to an exemplary embodiment, which can be applied in a terminal. To apply one or more aspects of the method, the terminal may access an account-managing module that is configured to manage log-in states and log-out states of accounts for one or more target applications. The account-managing module may be pre-configured to manage log-in states and log-out states of accounts for one or more specific target applications. Pre-configuring the account managing module may, for example, be performed prior to application of the method, at least with respect to a specific target application, such that after the pre-configuring the method can then be applied with respect to that specific target application. Pre-configuring the account-managing module may, for example, be performed by a manufacturer or a user of the terminal. As shown in FIG. 1, the method includes the following steps 101 and 102.

At step 101, a first log-out request for logging out a plurality of target accounts corresponding to at least one target application is received.

In embodiments of the present disclosure, the terminal can be any smart terminal equipped with a camera to capture pictures or videos, such as a smart mobile phone, a tablet computer, a Personal Digital Assistant (PDA) and the like.

At step 101, the first log-out request can be received through any of the following two exemplary manners.

In a first manner, the first log-out request is received through a log-out interface of the target application. Consistent with the first manner, pre-configuring the account-managing module to manage log-in states and log-out states of accounts for a target application may include configuring the account-managing module to receive from the target application a data version of a first log-out request and in response recognize the first log-out request as a request to log one or more accounts out of the target application. The first log-out request may be input by a user in a log-out interface of the target application, where the log-out interface of the target application is generated by the target application. The generated log-out interface of the target application may prompt the user to input a request to log one or more accounts out of the target application. The target application may be configured to detect that the input first log-out request requests that the one or more accounts be logged out of the target application. Consistent with the first manner, pre-configuring the account managing module to manage log-in states and log-out states of accounts for the target application may further include configuring the target application to, in response to the target application detecting that the input first log-out request requests that the one or more accounts be logged out of the target application, generate the data version of the first log-out request and send or otherwise provide the generated data version of the first log-out request to the account-managing module.

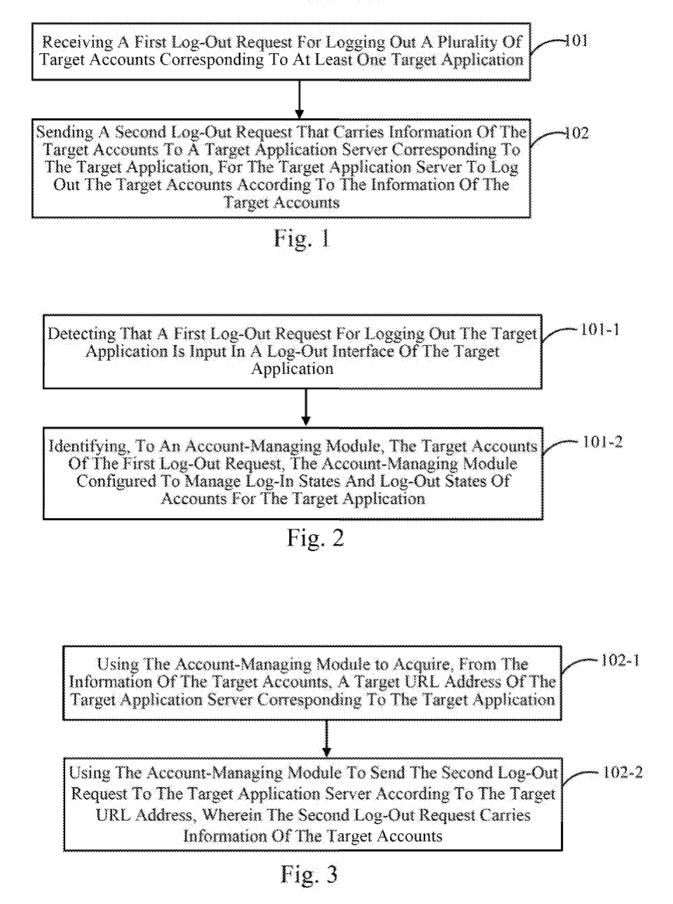

Optionally, as shown in FIG. 2, which is a flow chart illustrating aspects of a method for managing accounts based on the embodiment shown in FIG. 1, step 101 can include the following substeps 101-1 and 101-2.

At substep 101-1, for each target application, it is detected that a first log-out request for logging out of the target application is input in a log-out interface of the target application.

For example, at substep 101-1, after the terminal has previously logged in the target account of the target application, it can be detected whether the first log-out request is received through the log-out interface corresponding to the target application. Optionally, it can be detected whether a button for logging out in the log-out interface of the target application is selected. If the button for logging out is selected, it can be determined that the first log-out request is detected. In an exemplary embodiment of substep 101-1, a user could want to log out of two target applications, a first target application (e.g. a chat application) and a second target application (e.g. an e-mail application). A user could open the chat application on the terminal, navigate to the screen that displays a log-out button for the user to log an account out of the chat application, and select the button to log the account out of the chat application (i.e. input a first log-out request for a first target application). The chat application would then detect that the user selected the log-out button, generate data recognizable to the account-managing module as indicating that a log-out request had been made to log the account out of the chat application, and send the generated data to the account-managing module. Similarly, a user could later open the e-mail application on the terminal, navigate to the screen that displays a log-out button for the user to log an account out of the e-mail application, and select the button to log the account out of the e-mail application (i.e. input a first log-out request for a second target application). The e-mail application would then detect that the user selected the log-out button, generate data recognizable to the account-managing module as indicating that a request had been made to log the account out of the e-mail application, and send the generated data to the account-managing module.

At substep 101-2, an account-managing module receives identification of the target accounts of the first log-out request, the account-managing module configured to manage log-in states and log-out states of accounts for the target application.

In an embodiment of the present disclosure, the account-managing module is configured to manage the log-in states and log-out states of accounts for the target application. Upon detecting the first log-out request, the terminal can identify to the account-managing module the target accounts that are currently logged into the target application.

In a second manner, the first log-out request is received through a log-out interface of the account-managing module. Consistent with the second manner, pre-configuring the account-managing module to manage log-in states and log-out states of accounts for a target application may include configuring the account-managing module to generate, for the target application, a log-out interface of the account-managing module, the log-out interface of the account-managing module configured to receive a first log-out request that is a request to log one or more accounts out of the target application. The generated log-out interface of the account-managing module may prompt the user to input a request to log one or more accounts out of the target application. Consistent with the second manner, pre-configuring the account managing module to manage log-in states and log-out states of accounts for the target application may further include configuring the account-managing module to detect that the input first log-out request is a request that the one or more accounts be logged out of the target application.

Optionally, step 101 can include the following substep 101-1′.

At substep 101-1′, for each target application, a first log-out request input in a log-out interface of an account-managing module is received, the account-managing module configured to manage log-in states and log-out states of accounts for the target application.

At substep 101-1′, the terminal can detect whether the first log-out request is input in the log-out interface of the account-managing module.

Optionally, the account-managing module can output an account information list, and the account information list contains previously recorded information of all logged-in accounts that are managed by the account-managing module. The user can select, in the account information list, one or more target accounts to be logged out. After the user selects the target accounts, optionally, the user can click a button for logging out in the log-out interface of the account-managing module. Then, the terminal can determine that the first log-out request is received. In an exemplary embodiment of substep 101-1′, a user could want to log out of two target applications, a first target application (e.g. a chat application) and a second target application (e.g. an e-mail application). The user could navigate to the log-out interface of the account-managing module, which may include an account information list displaying the user's logged-in account with the chat application, the user's logged-in account with the e-mail application, and one or more other accounts logged into one or more other applications. In the information list, the user could select a box next to the user's logged-in account with the chat application and a box next to the user's logged-in account with the e-mail application to select these accounts. After both boxes were selected, the user could then click the button for logging out in the log-out interface (i.e. input a first log-out request for the two target applications), in order to log-out both accounts at the same time. Alternatively, the user could at a first time select a box next to the user's logged-in account with the chat application and click the button for logging out (i.e. input a first log-out request for the first target application), and then at a different second time select the box next to the user's logged-in account with the e-mail application and click the button for logging out (i.e. input a first log-out request for the second target application).

In an embodiment of the present disclosure, the account-managing module maintains information of all of the accounts that are managed by the account-managing module. All of the accounts that are managed by the account-managing module can be pre-set when the account-managing module is pre-configured to manage log-in states and log-out states of accounts for one or more specific target applications. All of the accounts that are managed by the account-managing module may include, for example, all accounts that a user of the terminal has registered with target applications, or all accounts of target applications that users of the terminal have logged in using the terminal. In order to ensure security of the information of the accounts, optionally, the account-managing module can encrypt and store the information of accounts that are managed by the account-managing module for an application.

At step 102, for each target application, a second log-out request that carries information of the target accounts is sent to a target application server corresponding to the target application, for the target application server to log out the target accounts according to the information of the target accounts.

Optionally, information of an account can include at least: a name of an application, a name of the account, a password for logging in, a URL address of an application server, and a log state (logged-in or logged-out). In an embodiment, when the terminal previously logged in the target account, the terminal recorded information of the target account in the account-managing module, for the account-managing module to manage log-in states and log-out states of accounts for the application.

At step 102, the account-managing module sends the second log-out request to the target application server corresponding to the target application. A target application server corresponding to a target application may be a server that is run by the third-party entity responsible for the target application. For example, a target application server corresponding to the chat application could be a server run by the chat application company, and a target application server corresponding to the e-mail application could be a server run by the e-mail application company. When respective second log-out requests are sent to a plurality of target application servers corresponding to a plurality of target applications, each second log-out request could be sent at the same time as the other second log-out requests, or second log-out requests could be sent at different times than some or all of the other second log-out requests.

As shown in FIG. 3, which is a flow chart illustrating aspects of a method for managing accounts based on the embodiment shown in FIG. 1, step 102 can include the following substeps 102-1 and 102-2.

At substep 102-1, the account-managing module acquires a target Uniform Resource Locator (URL) address of the target application server corresponding to the target application from the information of the target accounts.

Because the account-managing module previously recorded information of the target accounts, the account-managing module can, at step 102-1, acquire the target URL address of the corresponding target application server from the information of the target accounts.

At substep 102-2, the account-managing module sends the second log-out request, which carries the information of the target accounts to the target application server according to the target URL address.

For example, at substep 102-2, the account-managing module can send the second log-out request, which carries information of the target accounts, to the target application server according to the acquired target URL address, for the target application server to log out the corresponding target accounts according to the information of the target accounts.

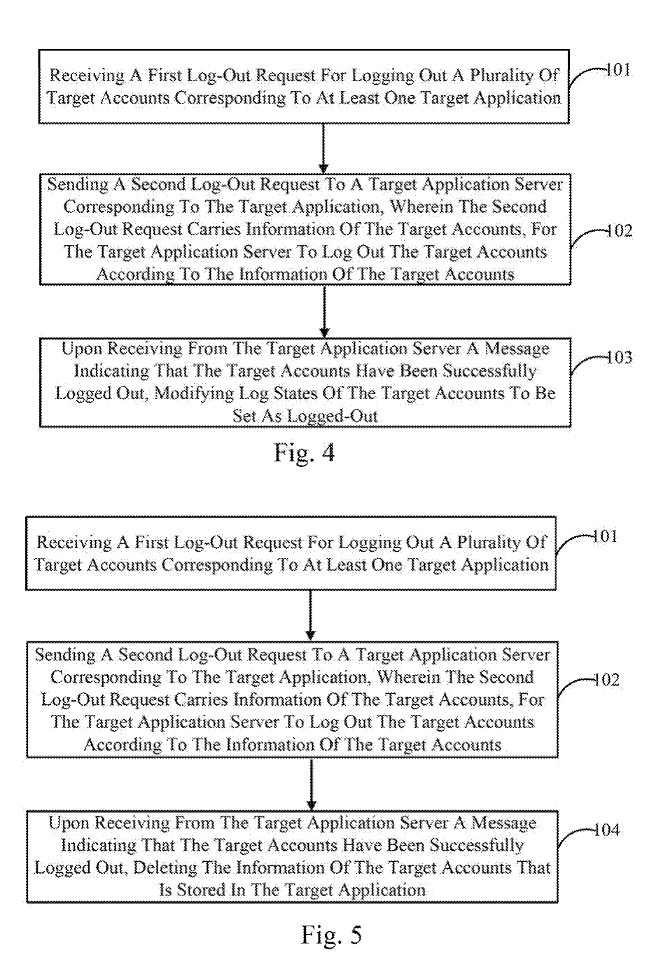

In an embodiment of the present disclosure, as shown in FIG. 4, which is a flow chart illustrating a method for managing accounts based on the embodiment shown in FIG. 1, the method can further include the following step 103.

At step 103, upon receiving from the target application server a message indicating that the target accounts have been successfully logged out, log states of the target accounts are modified to be set as logged-out.

For example, at step 103, after the target application server successfully logs out the target accounts according to the received information of the target accounts, the target application server can return to the terminal a message of successful logging-out the target accounts. Then, the terminal can modify the recorded log states in the information of the target accounts to be set as logged-out. In this way, the account-managing module can manage in real time the information of the target accounts.

In an embodiment of the present disclosure, as shown in FIG. 5, which is a flow chart illustrating a method for managing accounts based on the embodiment shown in FIG. 1, the method for managing accounts can further include the following step 104.

At step 104, upon receiving from the target application server a message indicating that the target accounts have been successfully logged out, the information of the target accounts that is stored in the target application is deleted.

For example, at step 104, after the terminal receives from the target application server a message indicating that the target accounts have been successfully logged out, the terminal can automatically delete the information of the target accounts stored locally. Then, when a user opens the target application once again, his account is already in a logged-out state. The previously stored information of the target account is invisible to the user, and the account name and password are required to be input again to log in the target account.

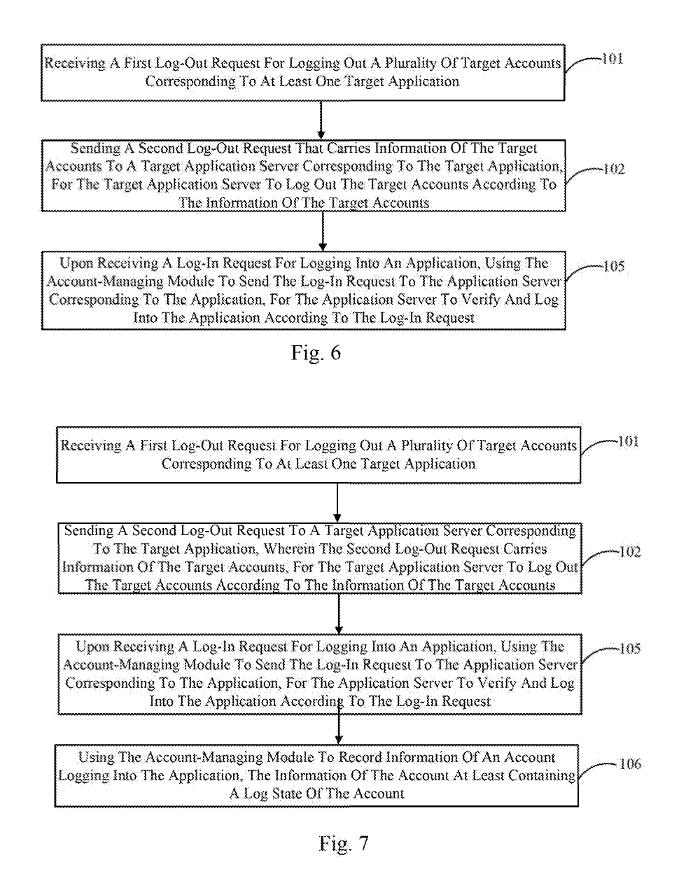

In an embodiment of the present disclosure, log-in states and log-out states of all of the accounts of the application are managed by the account-managing module, and the above described processes are for logging out target accounts. For logging into the application, as shown in FIG. 6, which is a flow chart illustrating aspects of a method for managing accounts based on the embodiment shown in FIG. 1, the method for managing accounts can include the following step 105.

At step 105, upon receiving a log-in request for logging in an application, the account-managing module sends the log-in request to the application server corresponding to the application, for the application server to verify and log into the application according to the log-in request.

For example, at step 105, for a user to log in a target account of the application, the account name and password may be required to be input in a log-in interface of the application. Further, the account-managing module can send the log-in request to the corresponding application server, for the application server to verify the information of the target account according to the log-in request. After the verification is passed, the application can be logged into.

In an embodiment of the present disclosure, as shown in FIG. 7, which is a flow chart illustrating a method for managing accounts based on the embodiment shown in FIG. 6, the method for managing accounts can further include the following step 106.

At step 106, the account-managing module records information of an account logging into the application, the information of the account at least containing a log state of the account.

For example, at step 106, the account-managing module records information of the account logging into the application. Optionally, the information of the account at least contains: a name of an application, a name of the account, a password for logging in, a URL address of an application server, and a log state (logged in or logged out).

After a message indicating that the target account has been successfully logged in is received from the application server, the log state of the target account is modified to be set as logged-in.

Optionally, for the security of the user accounts, the account-managing module can encrypt the recorded information of the logged-in target account such that other users cannot check the information of the logged-in target account on the terminal.

In above embodiments, after a first log-out request for logging out a plurality of target accounts is received, the terminal sends a second log-out request that carries information of the target accounts to a target application server corresponding to the target application, for the target application server to log out the target accounts according to the information of the target accounts. The above processes can quickly log out a plurality of target accounts, saving time for users and improving user experience.

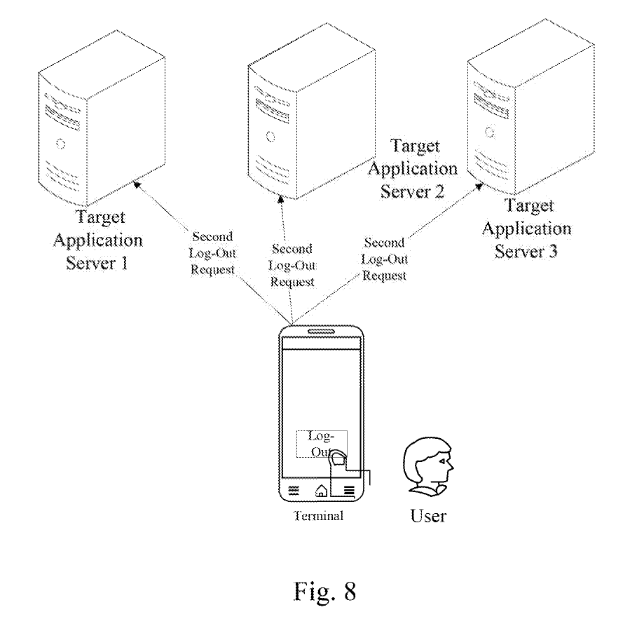

FIG. 8 is a flow chart illustrating a scenario for managing accounts according to an exemplary embodiment of the present disclosure, in which a user, a terminal, and one or more target application servers are involved.

As shown in FIG. 8, after the terminal receives a user initiated first log-out request for logging out a plurality of target accounts, the terminal sends one or more second log-out requests that carry information of the target accounts to one or more target application servers corresponding to the one or more target applications. After the one or more target application servers receive the one or more second log-out requests, the one or more target application servers log out the target accounts according to the information of the target accounts. Optionally, the terminal can detect whether there is a selection of a button for logging out in the respective log-out interface of each of the one or more target applications or in the log-out interface corresponding to the account-managing module, to determine whether the first log-out request is received.

In the embodiment described in connection with FIG. 8, after the terminal detects a first log-out request for logging out a plurality of target accounts, the terminal sends one or more second log-out requests that carry information of the target accounts to the one or more corresponding target application servers. Finally, the one or more target application servers log out the target accounts according to the information of the target accounts. In this way, time for the user to log out a plurality of target accounts can be saved, and user experience can be improved.

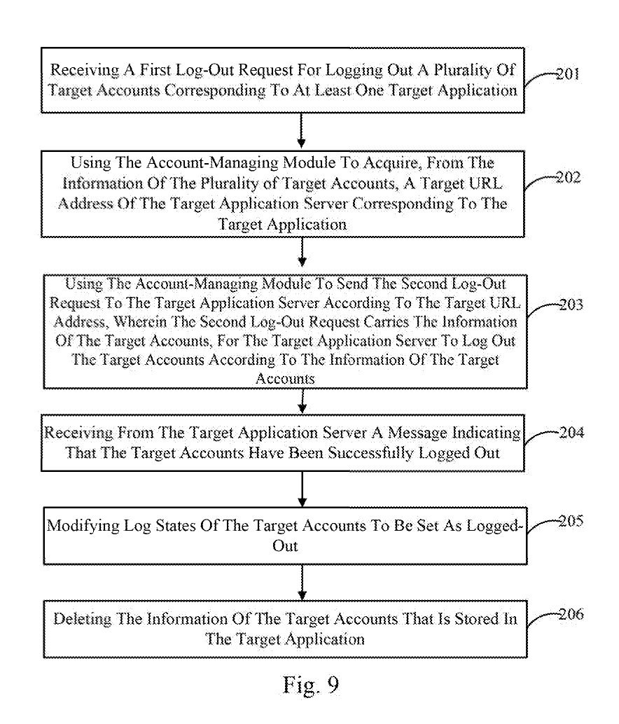

FIG. 9 is a flow chart illustrating a method for managing accounts according to an exemplary embodiment of the present disclosure, which involves a process for logging out a plurality of target accounts. As shown in FIG. 9, the method includes the following steps 201, 202, 203, 204, 205, and 206.

At step 201, a first log-out request for logging out a plurality of target accounts corresponding to at least one target application is received.

In this embodiment of the present disclosure, log-in states and log-out states of accounts for the at least one target application are managed by the account-managing module.

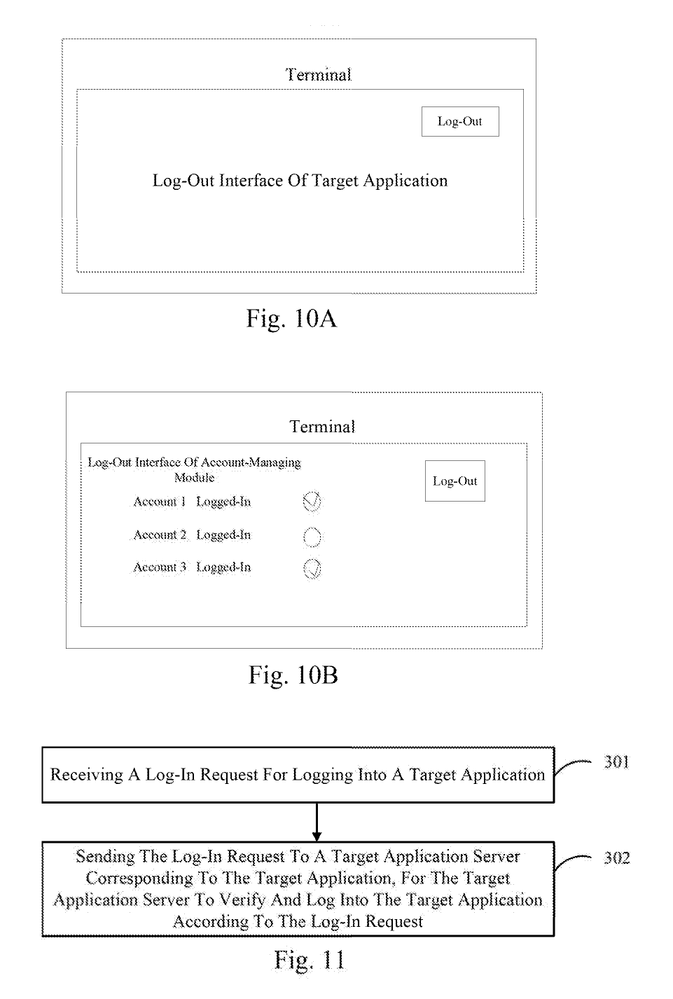

At step 201, it can be detected whether a button for logging out in the log-out interface of the target application is selected, as shown in FIG. 10A. Upon detection of the selection of the button for logging out, it can be determined that a first log-out request is received. The account-managing module receives an identification of the target accounts of the first log-out request.

Alternatively, at step 201, an account information list can be displayed on a log-out interface of the account-managing module, for the user to select one or more target accounts from the account information list to be logged out. In some embodiments, an account-managing module may be configured to manage accounts of a plurality of target applications, and an account information list displayed on a log-out interface of the account-managing module may include information of the accounts of the plurality of target applications. For example, in FIG. 10B, Account 1 may be an account of a first target application, Account 2 may be an account of a different second target application, and Account 3 may be an account of a third different target application. After the account information list is displayed on the log-out interface, it is detected whether a button for logging out in the log-out interface is selected, as shown in FIG. 10B. If the button is selected, it can be determined that a first log-out request is received.

At step 202, the account-managing module acquires a Uniform Resource Locator URL address of the respective target application server corresponding to the at least one target application from the information of the target accounts.

Optionally, information of an account can include at least: a name of an application, a name of the account, a password for logging in, a URL address of an application server, and a log state (logged in or logged out). Since the account-managing module previously recorded the information of the target accounts when the target accounts were previously logged in, at this time, the target URL address of the corresponding target application server can be directly acquired from the information of the target accounts.

At step 203, the account-managing module sends the second log-out request, which carries the information of the target accounts to the at least one target application server according to the one or more target URL addresses, for the at least one target application server to log out the target accounts according to the information of the target accounts.

At step 203, the account-managing module can, according to the acquired target URL address, send the second log-out request that carries the information of the target accounts to the at least one target application server, for logging out the corresponding target accounts.

At step 204, a message indicating that the target accounts have been successfully logged out is received from the at least one target application server.

After the at least one target application server successfully logs out the target accounts according to the received information of the target accounts, the at least one target application server can return to the terminal a message indicating that the target accounts have been successfully logged out.

At step 205, log states of the target accounts are modified to be set as logged-out.

For example, at step 205, the terminal can modify the recorded log states to be set as logged-out.

At step 206, the information of the target accounts that is stored in the at least one target application is deleted.

For example, at step 206, the terminal automatically deletes the information of the target accounts that is stored locally in the at least one target application. If the user lends the terminal to another user, when the another user enters the at least one target application again, it is already in a logged-out state. Then, the other user cannot see the information of the target account that was previously stored, and he is required to enter again the account name and password to log in the target account. Thereby, the method can ensure the security of the information of the account.

In the above embodiment described in connection with FIGS. 9, 10A, and 10B, after it is detected that a first log-out request for logging out a plurality of target accounts is input either in a log-out interface of the at least one target application or in a log-out interface of the account-managing module, the account-managing module acquires the at least one target URL address from the information of the target accounts, and sends a second log-out request that carries the information of the target accounts to the at least one target application server according to the target URL address, for the at least one target application server to log out the target accounts. The above process is convenient and fast to log out a plurality of target accounts, and thus can provide excellent user experience. Upon receiving from the at least one target application server at least one message indicating that the target accounts have been successfully logged out, the terminal can automatically modify log states of the target accounts to be set as logged-out, and also can delete the information of the target accounts that is stored in the at least one target application. Thereby, the method can ensure the security of the user information and improve the user experience.

The above process described in connection with FIGS. 9, 10A, and 10B is for logging out a plurality of target accounts. An embodiment of the present disclosure also provides a process for logging in a single target account. As shown in FIG. 11, which is a flow chart illustrating a method for managing accounts according to an exemplary embodiment of the present disclosure, the method includes the following steps 301 and 302.

At step 301, a log-in request for logging in a target application is received.

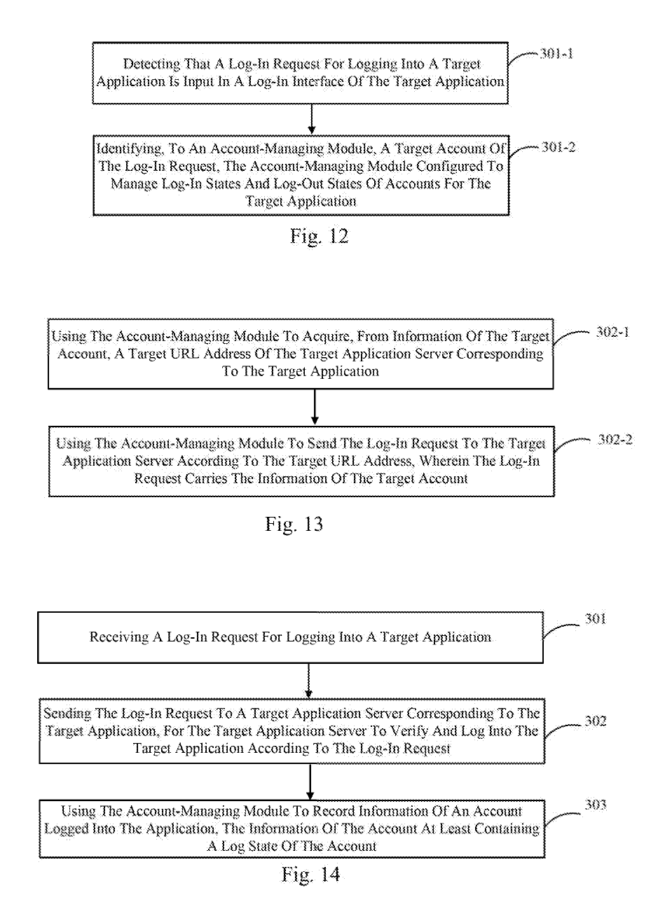

Optionally, as shown in FIG. 12, which shows aspects of a method for managing accounts based on the embodiment shown in FIG. 11, step 301 can also include the following substeps 301-1 and 301-2.

At substep 301-1, it is detected that a log-in request for logging in a target application is input in a log-in interface of the target application.

For example, at substep 301-1, the terminal can detect whether a log-in request is input in a log-in interface of the target application by utilizing related technology. Optionally, it can be detected whether a log-in button in the log-in interface is selected. When it is detected that the log-in button is selected, it can be determined that the log-in request is received.

At substep 301-2, an account-managing module receives identification of a target account corresponding to the log-in request, the account-managing module being configured to manage log-in states and log-out states of accounts for the target application.

The terminal acquires the identity of the target account corresponding to the log-in request input by the user. Because in embodiments of the present disclosure the log-in states and log-out states of the accounts of the target application are managed by the account-managing module, the terminal can identify, to the account-managing module, the target account corresponding to the log-in request after the terminal acquires the log-in request.

At step 302, the log-in request is sent to a target application server corresponding to the target application, for the target application server to verify and log in the target application according to the log-in request.

Optionally, as shown in FIG. 13, which shows aspects of a method for managing accounts based on the embodiment shown in FIG. 11, step 302 can also include the following substeps 302-1 and 302-2.

At substep 302-1, the account-managing module acquires a target Uniform Resource Locator URL address of the target application server corresponding to the target application.

At substep 302-1, the account-managing module can acquire the target URL address of the target application server from the information of the target account.

At substep 302-2, the account-managing module sends the log-in request, which carries the information of the target account to the target application server according to the target URL address.

For example, at substep 302-2, the account-managing module sends the log-in request that carries the information of the target account to the target application server according to the target URL address, for the application server to verify and log in the target application according to the log-in request.

Optionally, as shown in FIG. 14, which shows a method for managing accounts based on the embodiment shown in FIG. 11, the method for managing accounts can also include the following step 303.

At step 303, the account-managing module records information of an account logging into the application, the information of the account at least containing a log state of the account.

For example, at step 303, the account-managing module can record information of the accounts of all managed applications in an account information list. The account information includes at least information about log states.

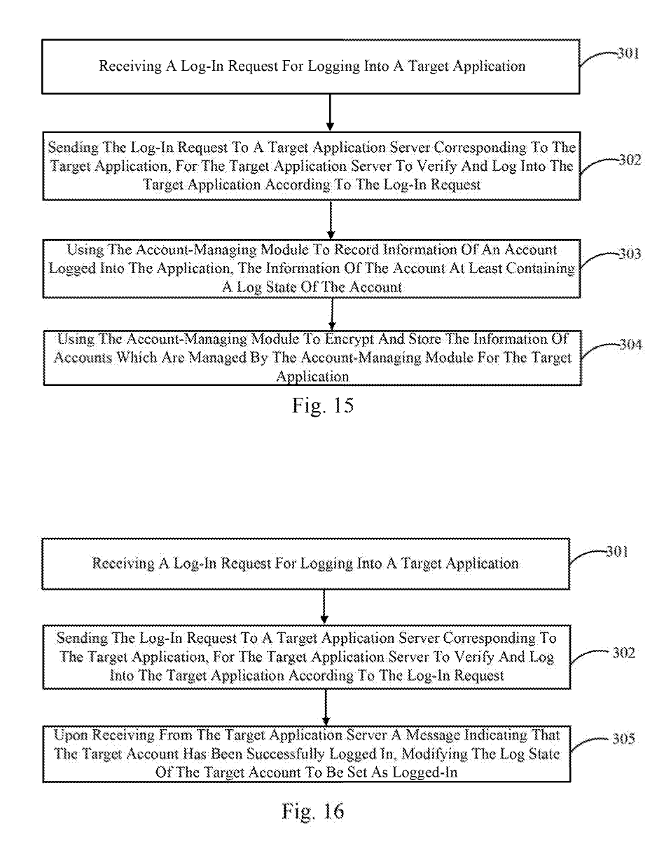

Optionally, as shown in FIG. 15, which shows a method for managing accounts based on the embodiment shown in FIG. 14, the method for managing accounts can also include the following step 304.

At step 304, the account-managing module encrypts and stores the information of accounts that are managed by the account-managing module for the application.

In order to ensure the security of user information, optionally, the account-managing module can encrypt and store the information of accounts that are managed by the account-managing module for the application.

Optionally, as shown in FIG. 16, which shows a method for managing accounts based on the embodiment shown in FIG. 11, the method for managing accounts can also include the following step 305.

At step 305, upon receiving from the target application server a message of successfully logging in the target account, the logging state of the target account is modified as logged-in.

At step 305, upon receiving a message indicating that the target account has been successfully logged in, the account-managing module modifies the recorded log state of the target account to be set as logged-in.

In above embodiments, in order to log into a single application, the account-managing module maintains all the account information of the managed accounts, for subsequently logging out a plurality of target accounts. Thereby, it can improve the efficiency of account management, save time for quickly logging out a plurality of accounts, and improve the user experience.

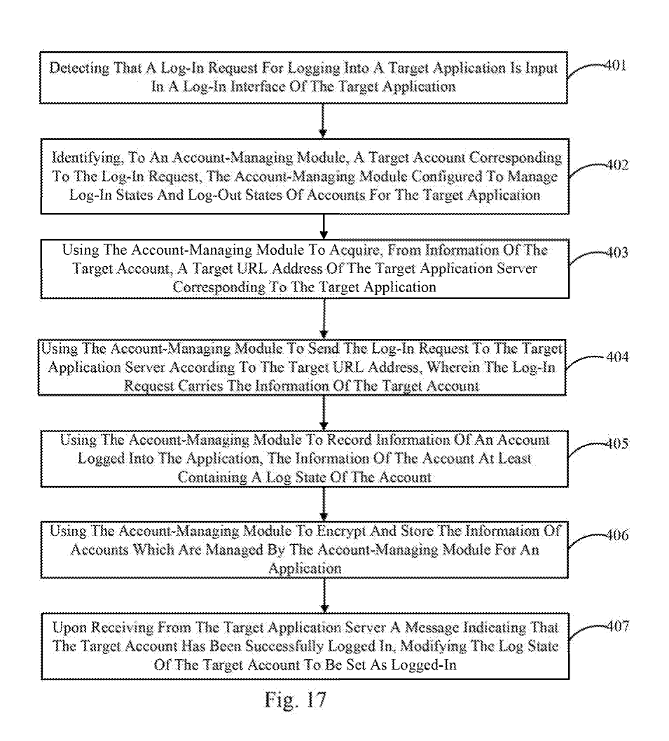

FIG. 17 is a flow chart illustrating a method for managing accounts according to an exemplary embodiment of the present disclosure, which describes a process for logging in a single account. The method includes the following steps 401, 402, 403, 404, 405, 406, and 407.

At step 401, it is detected that a log-in request for logging into a target application is input in a logging interface of the target application.

At this step, the user can open the log-in interface of the target application, and input the required account name and password in the log-in interface. After the account name and password are input, the user can click the log-in button. The terminal detects that the log-in button is selected, and then can determine that a log-in request is received.

At step 402, an account-managing module receives identification of a target account of the log-in request, the account-managing module configured to manage log-in states and log-out states of accounts for the target application.

The terminal acquires the identification of the target account of the log-in request input by the user. Because in the embodiment of the present disclosure the log-in states and log-out states of the accounts of the application are managed by the account-managing module, the terminal can identify to the account-managing module the target account of the log-in request after the terminal acquires the log-in request.

At step 403, the account-managing module acquires a target Uniform Resource Locator URL address of the target application server corresponding to the target application.

At step 403, the account-managing module can acquire the target URL address of the target application server from the information of the target account.

At step 404, the account-managing module sends the log-in request, which carries the information of the target account to the target application server according to the target URL address.

At step 404, the account-managing module sends the log-in request that carries the information of the target account to the target application server according to the target URL address, for the target application server to verify and log into the target application according to the log-in request.

At step 405, the account-managing module records information of an account logging into the application, the information of the account at least containing a log state of the account.

At step 405, the account-managing module can record information of the accounts of all of the previously logged-into applications of the terminal in an account information list. The account information list includes at least information about log states.

At step 406, the account-managing module encrypts and stores the information of accounts which are managed by the account-managing module for the application.

In order to ensure the security of user information, optionally, the account-managing module can encrypt and store the information of accounts which are managed by the account-managing module for the application.

At step 407, upon receiving from the target application server a message indicting that the target account has been successfully logged in, the log state of the target account is modified to be set as logged-in.

For example, at step 407, upon receiving a message indicating that the target account has been successfully logged in, the account-managing module modifies the recorded log state of the target account to be set as logged-in.

In the above embodiment described in connection with FIG. 17, after the terminal receives a log-in request for logging into the target application, the account-managing module sends the log-in request to the target application server corresponding to the target application, for the target application server to verify and log into the target application. In addition, information of the target account is recorded in the account-managing module, so that the account-managing module can maintain information of all accounts managed by the account-managing module. The method can thereby improve the efficiency of account management, save time for quickly logging out a plurality of accounts for subsequent users, and improve the user experience.

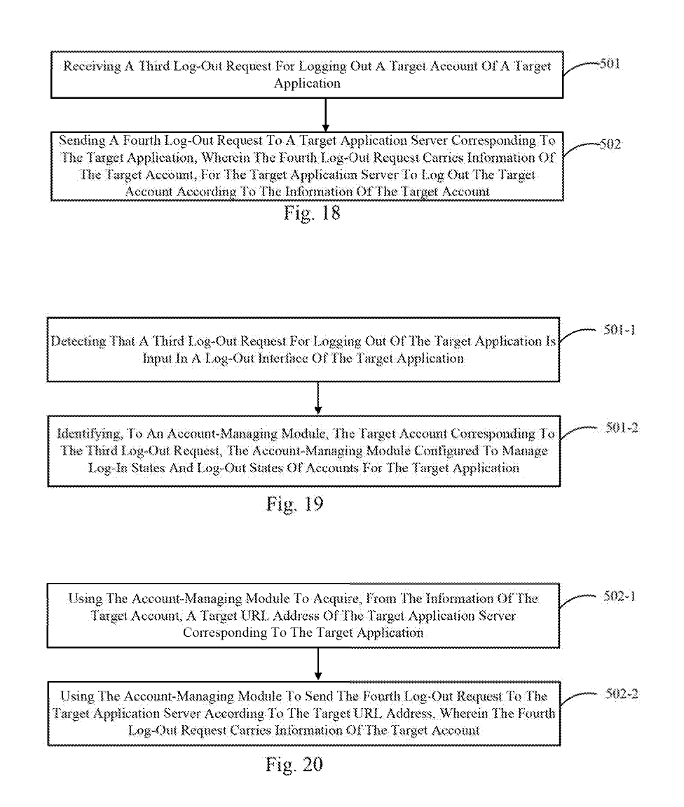

The embodiment of the present disclosure also provides a process for logging out a single target account. FIG. 18 is a flow chart illustrating a method for managing accounts according to an exemplary embodiment of the present disclosure. As shown in FIG. 18, the method includes the following steps 501 and 502.

At step 501, a third log-out request for logging a target account out of a target application is received.

Optionally, as shown in FIG. 19, which illustrates aspects of a method for managing accounts based on the embodiment as shown in FIG. 18, step 501 can include the following substeps 501-1 and 501-2.

At substep 501-1, it is detected that a third log-out request for logging out of the target application is input in a log-out interface of the target application.

At substep 501-1, after the terminal has previously logged in the target account of the target application, the terminal can detect whether a third log-out request is input in a log-out interface of the target application. Optionally, it can be detected whether a log-out button in the log-out interface of the target application is selected. If the log-out button is selected, it can be determined that the third log-out request is detected.

At substep 501-2, an account-managing module receives identification of the target account of the third log-out request, the account-managing module configured to manage log-in states and log-out states of accounts for the target application.

In an embodiment of the present disclosure, the account-managing module manages the log-in states and log-out states of accounts for the target application. After the terminal detects the third log-out request, the terminal can identify the target account that has logged into the target application to the account-managing module.

At step 502, a fourth log-out request, which carries information of the target account, is sent to a target application server corresponding to the target application, for the target application server to log out the target account according to the information of the target account.

FIG. 20 illustrates aspects of a method for managing accounts based on the embodiment as shown in FIG. 18. As shown in FIG. 20, step 502 can include the following substeps 502-1 and 502-2.

At substep 502-1, the account-managing module acquires, from the information of the target account, a target Uniform Resource Locator URL address of the target application server corresponding to the target application.

Because the account-managing module previously recorded the information of the target account, at step 502-1 the account-managing module can acquire the target URL address of the corresponding target application server from the information of the target account.

At substep 502-2, the account-managing module sends the fourth log-out request, which carries information of the target account to the target application server according to the target URL address.

At substep 502-2, the account-managing module can send the fourth log-out request, which carries information of the target account to the target application server according to the acquired target URL address, for the target application server to log out the corresponding target account according to the information of the target account.

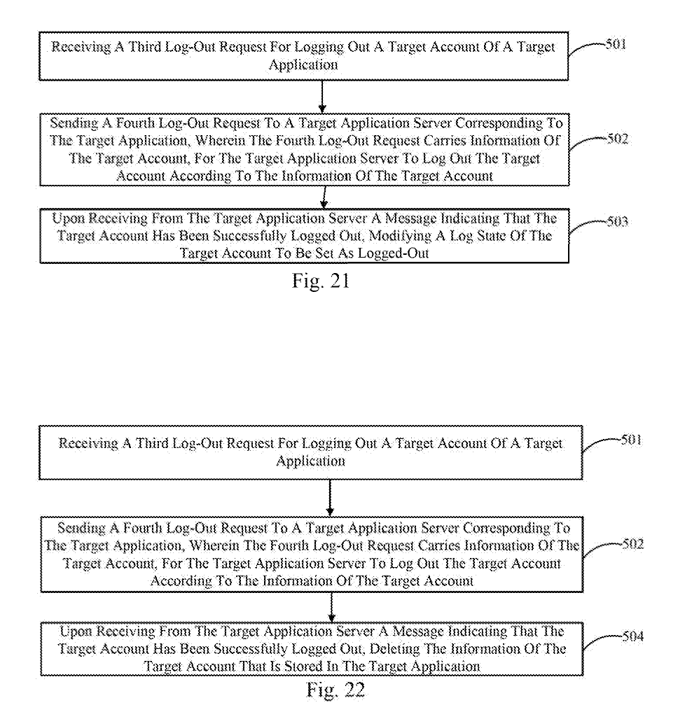

In an embodiment of the present disclosure, as shown in FIG. 21 which illustrates aspects of a method for managing accounts based on the embodiment as shown in FIG. 18, the method for managing accounts can also include the following step 503.

At step 503, upon receiving from the target application server a message indicating that the target account has been successfully logged out, a log state of the target account is modified to be set as logged-out.

At step 503, after the target application server successfully logs out the target account according to the received information of the target account, the target application server will return a message to the terminal indicating that the target account has been successfully logged out. Then, the terminal can modify the recorded log state of the target account to be set as logged-out. The account-managing module can thereby manage the information of the target account in real time.

In an embodiment of the present disclosure, as shown in FIG. 22, which illustrates a method for managing accounts based on the embodiment as shown in FIG. 18, the method for managing accounts can also include the following step 504.

In an embodiment of the present disclosure, as shown in FIG. 22, which illustrates a method for managing accounts based on the embodiment as shown in FIG. 18, the method for managing accounts can also include the following step 504.

At step 504, upon receiving from the target application server a message indicating that the target account has been successfully logged out, the information of the target account that is stored in the target application is deleted.

At step 504, after the terminal receives from the target application server the message indicating that the target account has been successfully logged out, the terminal can also automatically delete the information of the target accounts that is stored locally. Then, when a user opens the target application once again, his account is already in a logged-out state. The previously stored information of the target account is invisible to the user, and the account name and password are required to be input again to log in the target account.

In an embodiment, in order to log out of a single application, the account-managing module maintains information of all accounts managed by the account-managing module. The method can thereby improve the efficiency of account management, save time for quickly logging out a plurality of accounts, and improve the user experience.

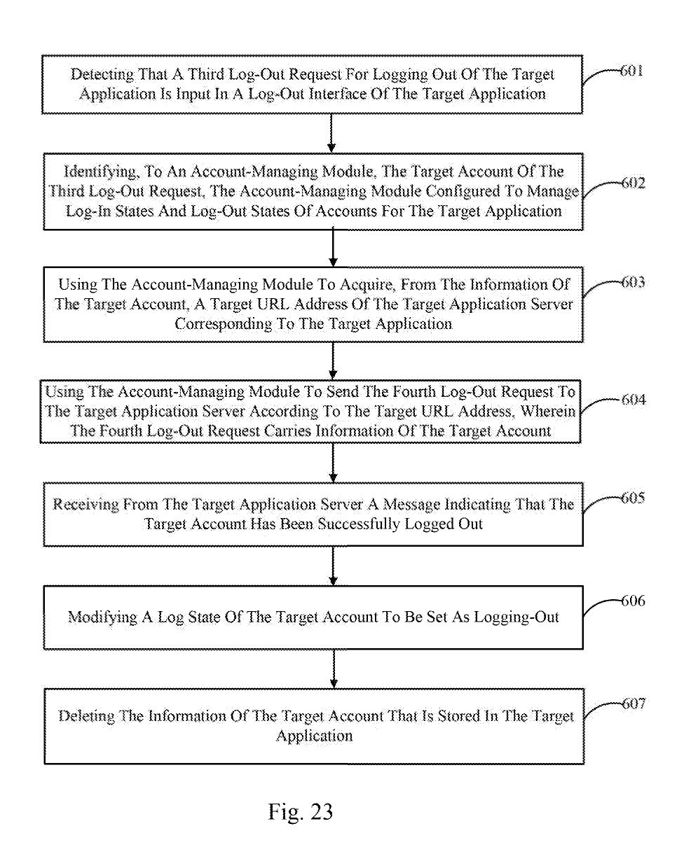

FIG. 23 is a flow chart illustrating a method for managing accounts according to an exemplary embodiment of the present disclosure, which describes a process of logging out a single account. The method includes the following steps 601, 602, 603, 604, 605, 606, and 607.

At step 601, it is detected that a third log-out request for logging out of the target application is input in a log-out interface of the target application.

For example, at step 601, after the terminal has already logged in the target account of the target application, the terminal can then detect whether a third log-out request is input in a log-out interface of the target application. Optionally, it can be detected whether a log-out button in the log-out interface of the target application is selected. If the log-out button is selected, it can be determined that the third log-out request is detected.

At step 602, an account-managing module receives identification of the target account of the third log-out request, the account-managing module configured to manage log-in states and log-out states of accounts for the target application.

In an embodiment of the present disclosure, the account-managing module manages the log-in states and log-out states of accounts for the target application. After the terminal detects the third log-out request, the terminal can identify, to the account-managing module, the target account which has logged into the target application.

At step 603, the account-managing module acquires a target Uniform Resource Locator URL address of the target application server corresponding to the target application.

Because the account-managing module previously recorded the information of the target account, at step 603, the account-managing module can acquire, from the information of the target account, the target URL address of the corresponding target application server.

At step 604, the account-managing module sends the fourth log-out request, which carries information of the target account to the target application server according to the target URL address.

For example, at step 604, the account-managing module can send the fourth log-out request that carries information of the target account to the target application server according to the acquired target URL address, for the target application server to log out the corresponding target account according to the information of the target account.

At step 605, a message indicating that the target account has been successfully logged out is received from the target application server.

For example, after the target application server successfully logs out the target account, the target application server returns to the terminal a message indicating that the target account has been successfully logged out

At step 606, a log state of the target account is modified to be set as logged-out.

For example, at step 606, the account-managing module can modify the log state of the target account, in the previously recorded information of the target account, from logged-in to logged-out.

At step 607, the information of the target account that is stored in the target application is deleted.

For example, at step 607, the information of the target account that is stored in the target application is deleted. Then, when a user opens the target application once again, his account is already in a logged-out state. The previously stored information of the target account is invisible to the user, and the account name and password are required to be input again to log in the target account, which ensures security of the information of the users.

In the above embodiment discussed in connection with FIG. 23, after the terminal receives the third log-out request for logging out the target account, the information of the target account can be acquired from the account-managing module according to the name of the target account. Then, the account-managing module sends the fourth log-out request to the target application server according to the target URL address in the information of the target account. The terminal can thereby maintain the information of all accounts managed by the account-managing module, improving the effectiveness of the account management and improving the user experience.

Corresponding to the above embodiments of methods for managing accounts, the present disclosure also provides embodiments of devices for managing accounts.

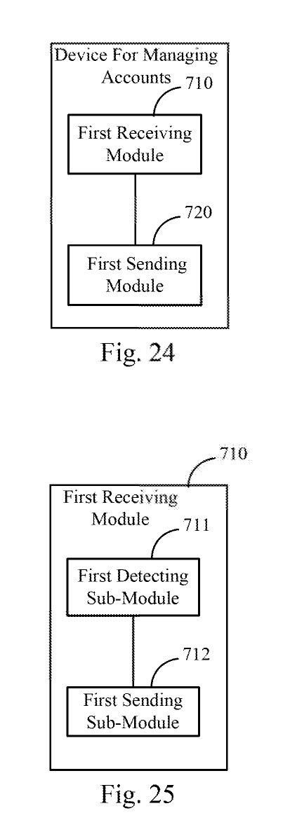

As shown in FIG. 24, which is a block diagram illustrating a device for managing accounts according to an exemplary embodiment of the present disclosure, the device includes a first receiving module 710 and a first sending module 720.

In an embodiment, the first receiving module 710 is configured to receive a first log-out request for logging out a plurality of target accounts corresponding to at least one target application.

In an embodiment, the first sending module 720 is configured to, for each target application, send a second log-out request that carries information of the target accounts to a target application server corresponding to the target application, for the target application server to log out the target accounts according to the information of the target accounts.

As shown in FIG. 25, which is a block diagram illustrating aspects of a device for managing accounts according to an exemplary embodiment of the present disclosure, based on the above embodiment as shown in FIG. 24, the first receiving module 710 includes: a first detecting sub-module 711 and a first sending sub-module 712.

In an embodiment, the first detecting sub-module 711 is configured to, for each target application, detect that a first log-out request for logging out the target application is input in a log-out interface of the target application.

In an embodiment, the first sending sub-module 712 is configured to identify, to an account-managing module, the target accounts of the first log-out request, the account-managing module configured to manage log-in states and log-out states of accounts for the target application.

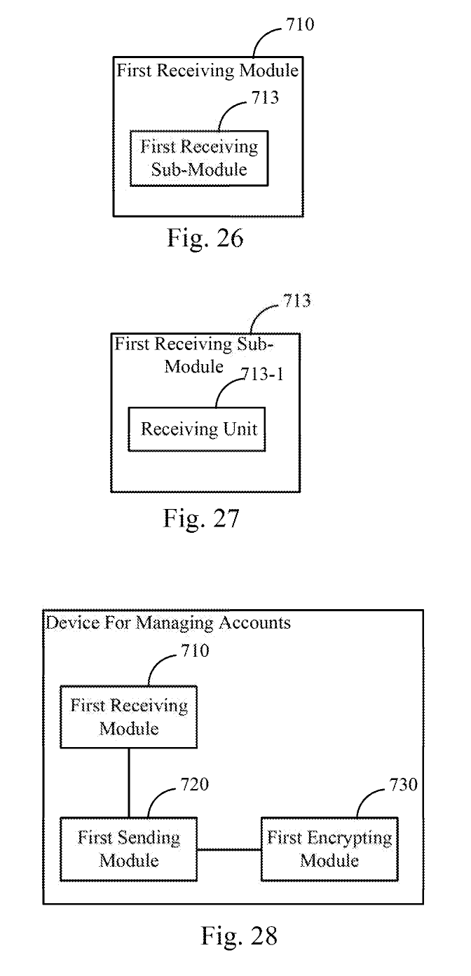

As shown in FIG. 26, which is a block diagram illustrating aspects of a device for managing accounts according to an exemplary embodiment of the present disclosure, based on the above embodiment as shown in FIG. 24, the first receiving module 710 includes: a first receiving sub-module 713.

In an embodiment, the first receiving sub-module 713 is configured to, for each target application, receive a first log-out request input in a log-out interface of an account-managing module, the account-managing module configured to manage log-in states and log-out states of accounts for the target application.

As shown in FIG. 27, which is a block diagram illustrating aspects of a device for managing accounts according to an exemplary embodiment of the present disclosure, based on the above embodiment as shown in FIG. 26, the first receiving sub-module 713 includes: a receiving unit 713-1.

In an embodiment, the receiving unit 713-1 is configured to receive a first log-out request by detecting that one or more target accounts are selected from an account information list of the account-managing module, the account information list containing previously recorded information of all managed accounts previously logged into the target application.

As shown in FIG. 28, which is a block diagram illustrating a device for managing accounts according to an exemplary embodiment of the present disclosure, based on the above embodiment as shown in FIG. 27, the device further includes: a first encrypting module 730.

In an embodiment, the first encrypting module 730 is configured as a component of the account-managing module, and to encrypt and store the information of accounts for an application that is managed by the account-managing module.

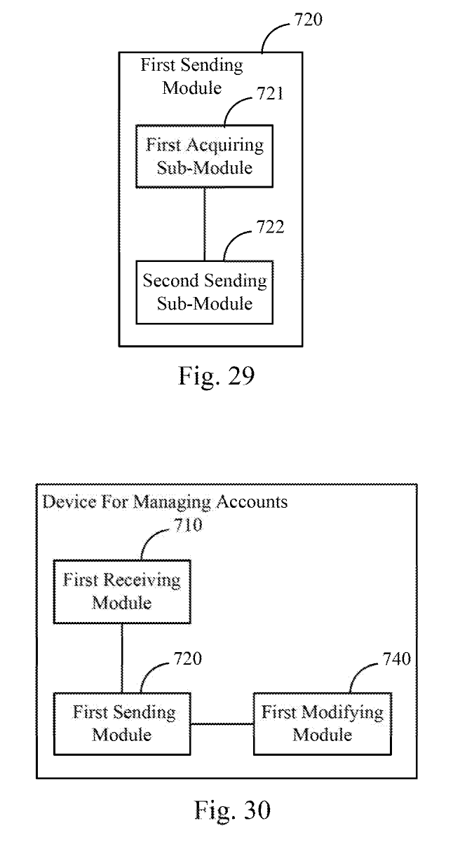

As shown in FIG. 29, which is a block diagram illustrating aspects of a device for managing accounts according to an exemplary embodiment of the present disclosure, based on any of the above embodiments as shown in FIGS. 24-28, the first sending module 720 includes: a first acquiring sub-module 721 and a second sending sub-module 722.

In an embodiment, the first acquiring sub-module 721 is configured as a component of the account-managing module, and to acquire a target Uniform Resource Locator URL address of the target application server corresponding to the target application from the information of the target accounts.

In an embodiment, the second sending sub-module 722 is configured as a component of the account-managing module, and to send the second log-out request, which carries the information of the target accounts, to the target application server according to the target URL address.

As shown in FIG. 30, which is a block diagram illustrating a device for managing accounts according to an exemplary embodiment of the present disclosure, based on the above embodiment as shown in FIG. 24, the device further includes: a first modifying module 740.

In an embodiment, the first modifying module 740 is configured to, upon receiving from the target application server a message indicating that the target accounts have been successfully logged out, modify log states of the target accounts to be set as logged-out.

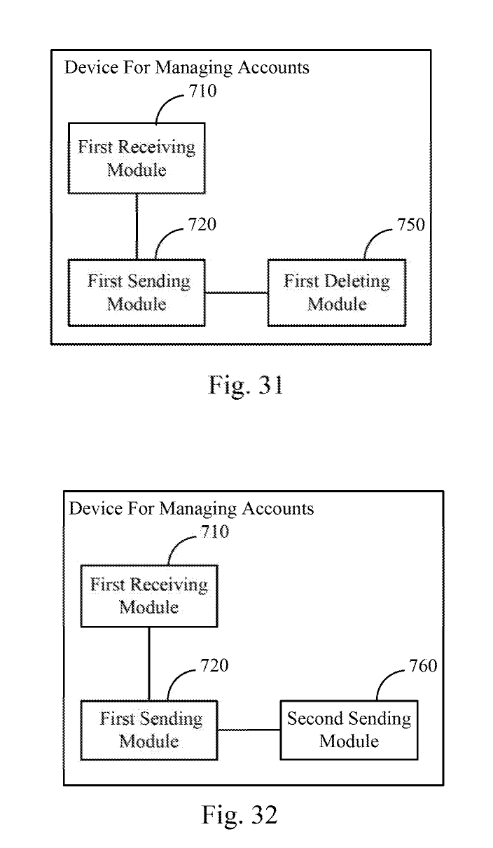

As shown in FIG. 31, which is a block diagram illustrating a device for managing accounts according to an exemplary embodiment of the present disclosure, based on the above embodiment as shown in FIG. 24, the device further includes: a first deleting module 750.

In an embodiment, the first deleting module 750 is configured to, upon receiving from the target application server a message indicating that the target accounts have been successfully logged out, delete the information of the target accounts that is stored in the target application.

As shown in FIG. 32, which is a block diagram illustrating a device for managing accounts according to an exemplary embodiment of the present disclosure, based on the above embodiment as shown in FIG. 24, the device further includes: a second sending module 760.

In an embodiment, the second sending module 760 is configured as a component of the account-managing module, and to, upon receiving a log-in request for logging in an application, send the log-in request to the application server corresponding to the application, for the application server to verify and log into the application according to the log-in request.

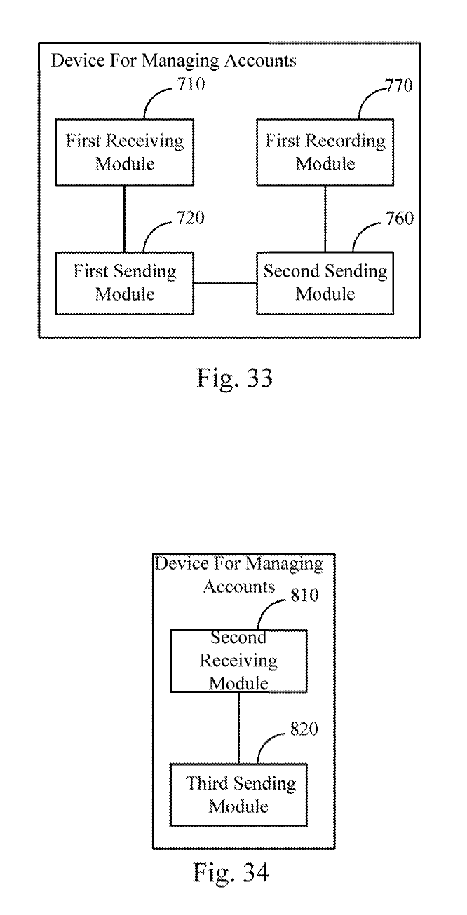

As shown in FIG. 33, which is a block diagram illustrating a device for managing accounts according to an exemplary embodiment of the present disclosure, based on the above embodiment as shown in FIG. 32, the device further includes: a first recording module 770.

In an embodiment, the first recording module 770 is configured as a component of the account-managing module, and to record information of an account logging into the application, the information of the account at least containing a log state of the account.

As shown in FIG. 34, which is a block diagram illustrating a device for managing accounts according to an exemplary embodiment of the present disclosure, the device includes: a second receiving module 810 and a third sending module 820.

In an embodiment, the second receiving module 810 is configured to receive a log-in request for logging into a target application.

In an embodiment, the third sending module 820 is configured to send the log-in request to a target application server corresponding to the target application, for the target application server to verify and log into the target application according to the log-in request.

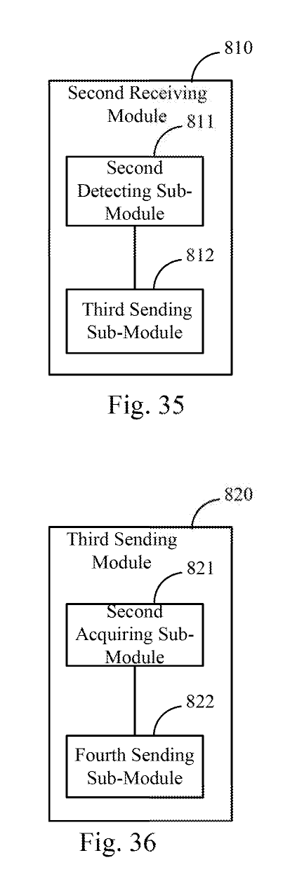

As shown in FIG. 35, which is a block diagram illustrating aspects of a device for managing accounts according to an exemplary embodiment of the present disclosure, based on the above embodiment as shown in FIG. 34, the second receiving module 810 includes: a second detecting sub-module 811 and a third sending sub-module 812.

In an embodiment, the second detecting sub-module 811 is configured to detect that a log-in request for logging into a target application is input in a log-in interface of the target application.

In an embodiment, the third sending sub-module 812 is configured to identify, to an account-managing module, a target account of the log-in request, the account-managing module being configured to manage log-in states and log-out states of accounts for the target application.

As shown in FIG. 36, which is a block diagram illustrating aspects of a device for managing accounts according to an exemplary embodiment of the present disclosure, based on the above embodiments as shown in FIG. 34 or FIG. 35, the third sending module 820 includes: a second acquiring sub-module 821 and a fourth sending sub-module 822.

In an embodiment, the second acquiring sub-module 821 is configured as a component of the account-managing module, and to acquire, from the information of the target account, a target Uniform Resource Locator URL address of the target application server corresponding to the target application.

In an embodiment the fourth sending sub-module 822 is configured as a component of the account-managing module, and to send the log-in request, which carries the information of the target account, to the target application server according to the target URL address.

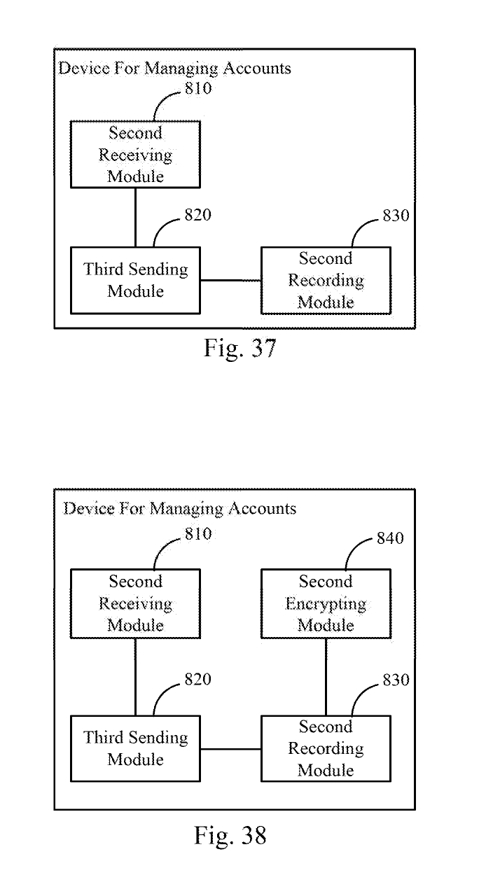

As shown in FIG. 37, which is a block diagram illustrating a device for managing accounts according to an exemplary embodiment of the present disclosure, based on the above embodiment as shown in FIG. 34, the device further includes: a second recording module 830.

In an embodiment, the second recording module 830 is configured as a component of the account-managing module, and to record information of an account logging into the application, the information of the account at least containing a log state of the account.

As shown in FIG. 38, which is a block diagram illustrating a device for managing accounts according to an exemplary embodiment of the present disclosure, based on the above embodiment as shown in FIG. 37, the device further includes: a second encrypting module 840.

In an embodiment, the second encrypting module 840 is configured as a component of the account-managing module, and to encrypt and store the information of accounts which are managed by the account-managing module for an application.

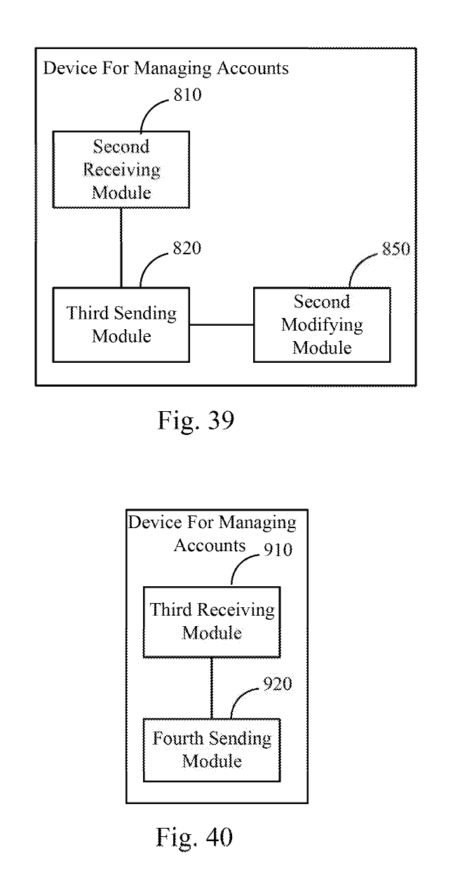

As shown in FIG. 39, which is a block diagram illustrating a device for managing accounts according to an exemplary embodiment of the present disclosure, based on the above embodiment as shown in FIG. 34, the device further includes: a second modifying module 850.

In an embodiment, the second modifying module 850 is configured to, upon receiving from the target application server a message indicating that the target account has been successfully logged in, modify the logging state of the target account to be set as logged-in.

As shown in FIG. 40, which is a block diagram illustrating a device for managing accounts according to an exemplary embodiment of the present disclosure, the device includes: a third receiving module 910 and a fourth sending module 920.

In an embodiment, the third receiving module 910 is configured to receive a third log-out request for logging out a target account of a target application.

In an embodiment, the fourth sending module 920 is configured to send a fourth log-out request, which carries information of the target account to a target application server corresponding to the target application, for the target application server to log out the target account according to the information of the target account.

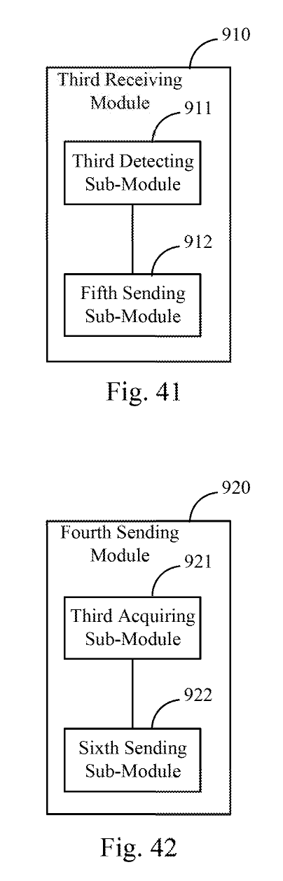

As shown in FIG. 41, which is a block diagram illustrating aspects of a device for managing accounts according to an exemplary embodiment of the present disclosure, based on the above embodiment as shown in FIG. 40, the third receiving module 910 includes: a third detecting sub-module 911 and a fifth sending sub-module 912.

In an embodiment, the third detecting sub-module 911 is configured to detect that a third log-out request for logging out of the target application is input in a log-out interface of the target application.

In an embodiment, the fifth sending sub-module 912 is configured to identify, to an account-managing module, the target account of the third log-out request, the account-managing module being configured to manage log-in states and log-out states of accounts for the target application.

As shown in FIG. 42, which is a block diagram illustrating aspects of a device for managing accounts according to an exemplary embodiment of the present disclosure, based on the above embodiment as shown in FIG. 40 or FIG. 41, the fourth sending module 920 includes: a third acquiring sub-module 921 and a sixth sending sub-module 922.

In an embodiment, the third acquiring sub-module 921 is configured as a component of the account-managing module, and to acquire, from the information of the target account, a target Uniform Resource Locator URL address of the target application server corresponding to the target application.

In an embodiment, the sixth sending sub-module 922 is configured as a component of the account-managing module, and to send the fourth log-out request, which carries information of the target account to the target application server according to the target URL address.

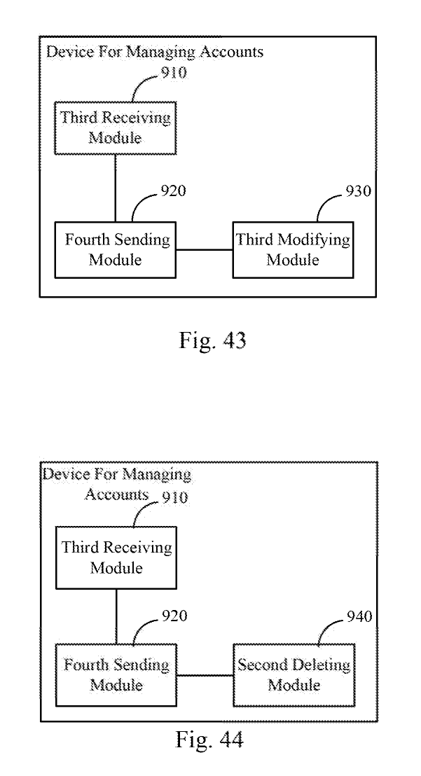

As shown in FIG. 43, which is a block diagram illustrating a device for managing accounts according to an exemplary embodiment of the present disclosure, based on the above embodiment as shown in FIG. 40, the device further includes: a third modifying module 930.

In an embodiment, the third modifying module 930 is configured to, upon receiving from the target application server a message of successfully logging out the target account, modify a log state of the target account to be set as logged-out.

As shown in FIG. 44, which is a block diagram illustrating a device for managing accounts according to an exemplary embodiment of the present disclosure, based on the above embodiment as shown in FIG. 40, the device further includes: a second deleting module 940.

In an embodiment, the second deleting module 940 is configured to, upon receiving from the target application server a message indicating that the target account has been successfully logged out, delete the information of the target account that is stored in the target application.

With respect to the devices in the above embodiments, the specific manners for performing operations for individual modules, sub-modules or units have been described in detail in the embodiments regarding the relevant methods, which will not be elaborated herein.

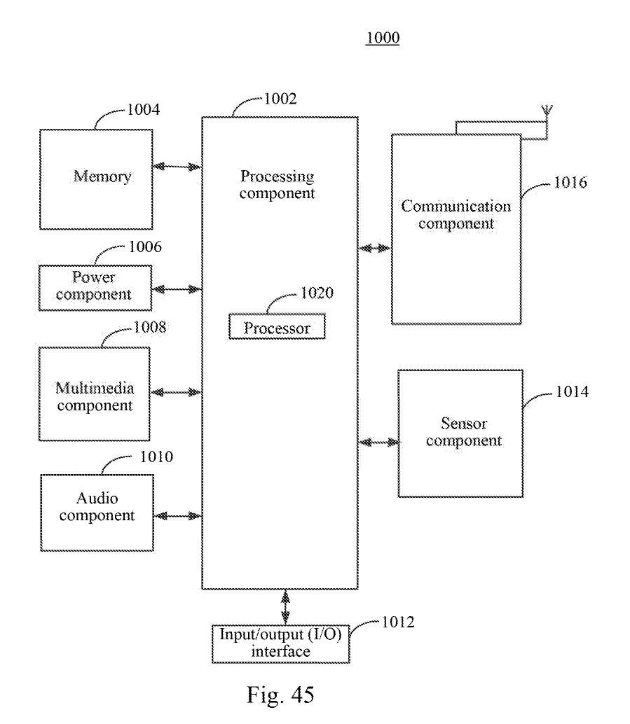

FIG. 45 is a block diagram of a device 1000 for managing accounts according to an exemplary embodiment. For example, the device 1000 can be a terminal, and the terminal can specifically be a mobile phone, a computer, a digital broadcast terminal, a messaging device, a smart socket, a smart sphygmomanometer, a gaming console, a tablet, a medical device, exercise equipment, a personal digital assistant, and the like.

Referring to FIG. 45, the device 1000 can include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the device 1000, such as the operations associated with display, telephone calls, data communications, camera operations, and recording operations. The processing component 1002 can include one or more processors 1020 to execute instructions to perform all or part of the steps in the above described methods. Moreover, the processing component 1002 can include one or more modules which facilitate the interaction between the processing component 1002 and other components. For instance, the processing component 1002 can include a multimedia module to facilitate the interaction between the multimedia component 1008 and the processing component 1002.

The memory 1004 is configured to store various types of data to support the operation of the device 1000. Examples of such data include instructions for any applications or methods operated on the device 1000, contact data, phonebook data, messages, pictures, video, etc. The memory 1004 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the device 1000. The power component 1006 can include a power management system, one or more power sources, and any other components associated with the generation, management, and distribution of power in the device 1000.

The multimedia component 1008 includes a screen providing an output interface between the device 1000 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors can not only sense a boundary of a touch or swipe action, but also sense a period of time and a pressure associated with the touch or swipe action. In some embodiments, the multimedia component 1008 includes a front camera and/or a rear camera. The front camera and the rear camera can receive an external multimedia datum while the device 1000 is in an operation mode, such as a photographing mode or a video mode. Each of the front camera and the rear camera can be a fixed optical lens system or have focus and optical zoom capability.

The audio component 1010 is configured to output and/or input audio signals. For example, the audio component 1010 includes a microphone (“MIC”) configured to receive an external audio signal when the device 1000 is in an operation mode, such as a call mode, a recording mode, and a voice recognition mode. The received audio signal can be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons can include, but are not limited to, a home button, a volume button, a starting button, and a locking button.

The sensor component 1014 includes one or more sensors to provide status assessments of various aspects of the device 1000. For instance, the sensor component 1014 can detect an open/closed status of the device 1000, relative positioning of components, e.g., the display and the keypad, of the device 1000, a change in position of the device 1000 or a component of the device 1000, a presence or absence of user contact with the device 1000, an orientation or an acceleration/deceleration of the device 1000, and a change in temperature of the device 1000. The sensor component 1014 can include a proximity sensor configured to detect the presence of nearby objects without any physical contact. The sensor component 1014 can also include a light sensor, such as a CMOS or CCD image sensor, for use in imaging applications. In some embodiments, the sensor component 1014 can also include an accelerometer sensor, a gyroscope sensor, a magnetic sensor, a pressure sensor, a microwave sensor or a temperature sensor.

The communication component 1016 is configured to facilitate communication, wired or wirelessly, between the device 1000 and other devices. The device 1000 can access a wireless network based on a communication standard, such as WiFi, 2, or 3G, or a combination thereof. In one exemplary embodiment, the communication component 1016 receives a broadcast signal or broadcast associated information from an external broadcast management system via a broadcast channel. In one exemplary embodiment, the communication component 1016 further includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the device 1000 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1004, executable by the processor 1020 in the device 1000, for performing the above-described methods. For example, the non-transitory computer-readable storage medium can be a ROM, a RAM, a CD-ROM, a magnetic tape, a floppy disc, an optical data storage device, and the like.

The methods, devices, and modules described above may be implemented in many different ways and as hardware, software or in different combinations of hardware and software. For example, all or parts of the implementations may be a processing circuitry that includes an instruction processor, such as a central processing unit (CPU), microcontroller, a microprocessor, or application specific integrated circuits (ASICs), digital signal processors (DSPs), digital signal processing devices (DSPDs), programmable logic devices (PLDs), field programmable gate arrays (FPGAs), controllers, micro-controllers, microprocessors, other electronic components; or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Each module discussed above, such as the first receiving module 710, first sending module 720, first detecting sub-module 711, first sending sub-module 712, first receiving sub-module 713, receiving unit 713-1, first encrypting module 730, first acquiring sub-module 721, second sending sub-module 722, first modifying module 740, first deleting module 750, second sending module 760, first recording module 770, second receiving module 810, third sending module 820, second detecting sub-module 811, third sending sub-module 812, second acquiring sub-module 821, fourth sending sub-module 822, second recording module 830, second encrypting module 840, second modifying module 850, third receiving module 910, fourth sending module 920, third detecting sub-module 911, fifth sending sub-module 912, third acquiring sub-module 921, sixth sending sub-module 922, third modifying module 930, and second deleting module 940, may take the form of a packaged functional hardware unit designed for use with other components, a portion of a program code (e.g., software or firmware) executable by the processor 1020 or the processing circuitry that usually performs a particular function of related functions, or a self-contained hardware or software component that interfaces with a larger system, for example.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

Above description is merely for purpose of illustrating preferable embodiments of the present disclosure rather than applying limitation thereto. Any modification, equivalent substitution or improvement made without departing from the spirit and principle of the disclosure should fall into protection scope of the present disclosure.

What is claimed is:

1. A method for managing accounts, the method comprising:
receiving, by a processor, a first log-out request for logging out a plurality of target accounts corresponding to at least one target application; and
for each target application of the at least one target application, sending, from the processor to a target application server corresponding to the target application, a second log-out request that carries information of the plurality of target accounts, for the target application server to log out the plurality of target accounts according to the information of the plurality of target accounts.

2. The method of claim 1, wherein the receiving of a first log-out request for logging out a plurality of target accounts comprises:
for each target application of the at least one target application:
detecting that a first log-out request for logging out of the target application is input in a log-out interface of the target application; and
identifying, to an account-managing module, the plurality of target accounts of the first log-out request, the account-managing module configured to manage log-in states and log-out states of accounts for the target application.

3. The method of claim 1, wherein the receiving of a first log-out request for logging out a plurality of target accounts comprises:
for each target application of the at least one target application, receiving a first log-out request input in a log-out interface of an account-managing module, the account-managing module configured to manage log-in states and log-out states of accounts for the target application.

4. The method of claim 3, wherein the receiving of a first log-out request input in a log-out interface of an account-managing module comprises:
receiving a first log-out request by detecting that one or more target accounts are selected from an account information list of the account-managing module, the account information list containing previously recorded information of all logged-in accounts that are managed by the account-managing module.

5. The method of claim 2, further comprising:
with the account-managing module, encrypting and storing information of accounts that are managed by the account-managing module for an application.

6. The method of claim 1, further comprising:
upon receiving from the target application server a message indicating the target accounts have been successfully logged out, modifying log states of the target accounts to be set as logged-out.

7. The method of claim 1, wherein the method further comprises:
upon receiving from the target application server a message indicating the target accounts have been successfully logged out, deleting information of the target accounts that is stored in the target application.

8. The method of claim 1, wherein the method further comprises:
upon receiving a log-in request for logging into an application, sending the log-in request from the account-managing module to an application server corresponding to the application, for the application server to verify and log into the application according to the log-in request.

9. A method for managing accounts, the method comprising:
receiving, by a processor, a log-in request for logging a target account into a target application; and
sending the log-in request, from the processor to a target application server corresponding to the target application, for the target application server to verify and log the target account into the target application according to the log-in request,
wherein the receiving of a log-in request for logging a target account into a target application comprises:
detecting that a log-in request for logging into a target application is input in a log-in interface of the target application; and
identifying, to an account-managing module, the target account of the log-in request, the account-managing module configured to manage log-in states and log-out states of accounts for the target application.

10. A method for managing accounts, the method comprising:
receiving, by a processor, a third log-out request for logging a target account out of a target application; and
sending, from the processor to a target application server corresponding to the target application, a fourth log-out request that carries information of the target account, for the target application server to log out the target account according to the information of the target account,
wherein the receiving of a third log-out request for logging a target account out of a target application comprises:
detecting that a third log-out request for logging out the target application is input in a log-out interface of the target application; and
identifying, to an account-managing module, the target account of the third log-out request, the account-managing module configured to manage log-in states and log-out states of accounts for the target application.

11. A device for managing accounts, the device comprising:
a processor; and
a memory for storing instructions executable by the processor;
wherein the processor is configured to perform operations of:
receiving a first log-out request for logging out a plurality of target accounts corresponding to at least one target application; and
for each target application of the at least one target application, sending a second log-out request that carries information of the plurality of target accounts to a target application server corresponding to the target application, for the target application server to log out the plurality of target accounts according to the information of the plurality of target accounts.

12. The device of claim 11, wherein the receiving of a first log-out request for logging out a plurality of target accounts comprises:
for each target application of the at least one target application:
detecting that a first log-out request for logging out of the target application is input in a log-out interface of the target application; and
identifying, to an account-managing module, the plurality of target accounts of the first log-out request, the account-managing module configured to manage log-in states and log-out states of accounts for the target application.

13. The device of claim 1, wherein the receiving of a first log-out request for logging out a plurality target accounts comprises:
for each target application of the at least one target application, receiving a first log-out request input in a log-out interface of an account-managing module, the account-managing module configured to manage log-in states and log-out states of accounts for the target application.

14. The device of claim 13, wherein the receiving of a first log-out request input in a log-out interface of an account-managing module comprises:
receiving a first log-out request by detecting that one or more target accounts are selected from an account information list of the account-managing module, the account information list containing previously recorded information of all logged-in accounts that are managed by the account-managing module.

15. The device of claim 12, wherein the processor is further configured to perform operations of, with the account-managing module, encrypting and storing information of accounts that are managed by the account-managing module for an application.

16. The device of claim 11, wherein the processor is further configured to perform an operation of:
upon receiving from the target application server a message indicating the target accounts have been successfully logged out, modifying log states of the target accounts to be set as logged-out.

17. The device of claim 11, wherein the processor is further configured to perform an operation of:
upon receiving from the target application server a message indicating the target accounts have been successfully logged out, deleting information of the target accounts that is stored in the target application.

18. The device of claim 11, wherein the processor is further configured to perform an operation of, upon receiving a log-in request for logging into an application, sending the log-in request from the account-managing module to an application server corresponding to the application, for the application server to verify and log into the application according to the log-in request.

19. A device for managing accounts, the device comprising:
a processor; and
a memory for storing instructions executable by the processor;
wherein the processor is configured to perform operations of:
receiving a log-in request for logging a target account into a target application; and
sending the log-in request to a target application server corresponding to the target application, for the target application server to verify and log the target account into the target application according to the log-in request,
wherein the receiving of a log-out request for logging a target account out of a target application comprises:
detecting that a log-in request for logging into a target application is input in a log-in interface of the target application; and
identifying, to an account-managing module, the target account of the log-in request, the account-managing module configured to manage log-in states and log-out states of accounts for the target application.

20. A device for managing accounts, comprising:
a processor; and
a memory for storing instructions executable by the processor,
wherein the processor is configured to perform operations of:
receiving a third log-out request for logging a target account out of a target application; and
sending, to a target application server corresponding to the target application, a fourth log-out request that carries information of the target account, for the target application server to log out the target account according to the information of the target account,
wherein the receiving of a third log-out request for logging a target account out of a target application comprises:
detecting that a third log-out request for logging out the target application is input in a log-out interface of the target application; and
identifying, to an account-managing module, the target account of the third log-out request, the account-managing module configured to manage log-in states and log-out states of accounts for the target application.
